(19) United States
(12) Patent Application Publication
(10) Pub. No.: US 2025/0330004 A1
(43) Pub. Date: Oct. 23, 2025

(54) JUNCTION BOX

(71) Applicant: YAZAKI CORPORATION, Tokyo (JP)

(72) Inventors: Airi Matsuura, Kakegawa-shi (JP); Hirotaka Mukasa, Kakegawa-shi (JP); Ryu Senoo, Kakegawa-shi (JP); Yudai Sumizawa, Kakegawa-shi (JP)

(21) Appl. No.: 19/181,356

(22) Filed: Apr. 17, 2025

(30) Foreign Application Priority Data
Apr. 22, 2024 (JP) 2024-069137

(51) Int. Cl. H02G 3/08; B60R 16/023

(52) U.S. Cl. CPC H02G 3/088; B60R 16/0239; H02G 3/081

(57) ABSTRACT

A junction box includes: a housing including a first housing member and a second housing member, the second housing member overlapping the first housing member in a first direction and forming a housing chamber together with the first housing member, the housing chamber housing an electronic component; and a sealing member disposed outside the housing chamber when viewed from the first direction and compressed in the first direction by the first housing member and the second housing member. A sealing groove that is formed outside the housing chamber when viewed from the first direction, that opens in the first direction, and in which the sealing member is disposed is formed in the first housing member. A drain groove formed on a face being in contact with the sealing member is formed in at least one of the first housing member and the second housing member.

### BACKGROUND OF THE INVENTION

### Field of the Invention

An embodiment of the present invention relates to a junction box.

Priority is claimed on Japanese Patent Application No. 2024-069137, filed Apr. 22, 2024, the contents of which are incorporated herein by reference.

### Description of Related Art

For example, in Japanese Unexamined Patent Application, First Publication, No. 2022-99475, a junction box mounted on a vehicle is disclosed. In the junction box, a plurality of electronic components are mounted.

### SUMMARY OF THE INVENTION

In recent electric vehicles, the diversification of vehicle architectures and optimization of circuit branching have created a need for a high-voltage junction box having waterproof performance that can withstand salt damage. For example, there is a case where saltwater enters from a gap between a housing and a packing of a junction box and causes the salt in the saltwater to crystallize inside the junction box. For these reasons, there is a need to prevent saltwater from entering the inside of the junction box.

One embodiment provides a junction box that can prevent saltwater from entering the junction box.

The junction box of one embodiment includes a housing including a first housing member and a second housing member, the second housing member overlapping the first housing member in a first direction and forming a housing chamber together with the first housing member, the housing chamber housing an electronic component; and a sealing member disposed outside the housing chamber when viewed from the first direction and compressed in the first direction by the first housing member and the second housing member, wherein a sealing groove that is formed outside the housing chamber when viewed from the first direction, that opens in the first direction, and in which the sealing member is disposed is formed in the first housing member, and a drain groove formed on a face being in contact with the sealing member is formed in at least one of the first housing member and the second housing member.

One embodiment of the present invention provides a junction box that can prevent saltwater from entering the junction box.

### BRIEF DESCRIPTION OF THE DRAWINGS

FIG. 1 is a partial cross-sectional view of a junction box according to an embodiment.

FIG. 2 is an exploded perspective view of a housing according to the embodiment.

FIG. 3 is a plan view of a case according to the embodiment.

FIG. 4 is a plan view of a cover according to the embodiment.

FIG. 5 is an enlarged cross-sectional view of a V portion of FIG. 1.

FIG. 6 is a cross-sectional view showing a state before sealing of a sealing member according to the embodiment.

FIG. 7 is a plan view of a first drain groove when viewed from a Z direction according to the embodiment.

FIG. 8 is a cross-sectional view of a drain groove according to a modification of the embodiment.

FIG. 9 is a cross-sectional view of a drain groove according to a modification of the embodiment.

FIG. 10 is a cross-sectional view of a drain groove according to a modification of the embodiment.

### DETAILED DESCRIPTION OF THE INVENTION

An embodiment will be explained below with reference to the drawings.

### Junction Box

As shown in FIG. 1, a junction box 1 includes a housing 2, a sealing member 3, a base member 4, electronic components 5, and bus bar 6. For example, the junction box 1 is mounted on the outside of a battery pack of an electric vehicle or the like.

### Housing

The housing 2 has a housing chamber 7 for housing a plurality of electronic components 5 and the like therein. The housing 2 is made of a conductive material such as aluminum. The housing 2 has a case 10 (a first housing member), a cover 15 (a second housing member). The case 10 and the cover 15 are disposed so as to face each other.

Hereinafter, a direction in which the case 10 and the cover 15 face each other is defined as a Z direction (a first direction). A direction from the case 10 to the cover 15 is +Z direction, a direction from the cover 15 to case 10 is −Z direction. In addition, in a face facing the Z direction, directions that intersect each other are defined as an X direction and a Y direction. In an example of the present embodiment, the X direction, the Y direction, and the Z direction are directions orthogonal to each other. In addition, in this example, the Z direction is a vertical direction. Further, in this example, the +Z direction is an upward direction, and the −Z direction is a downward direction.

### Case

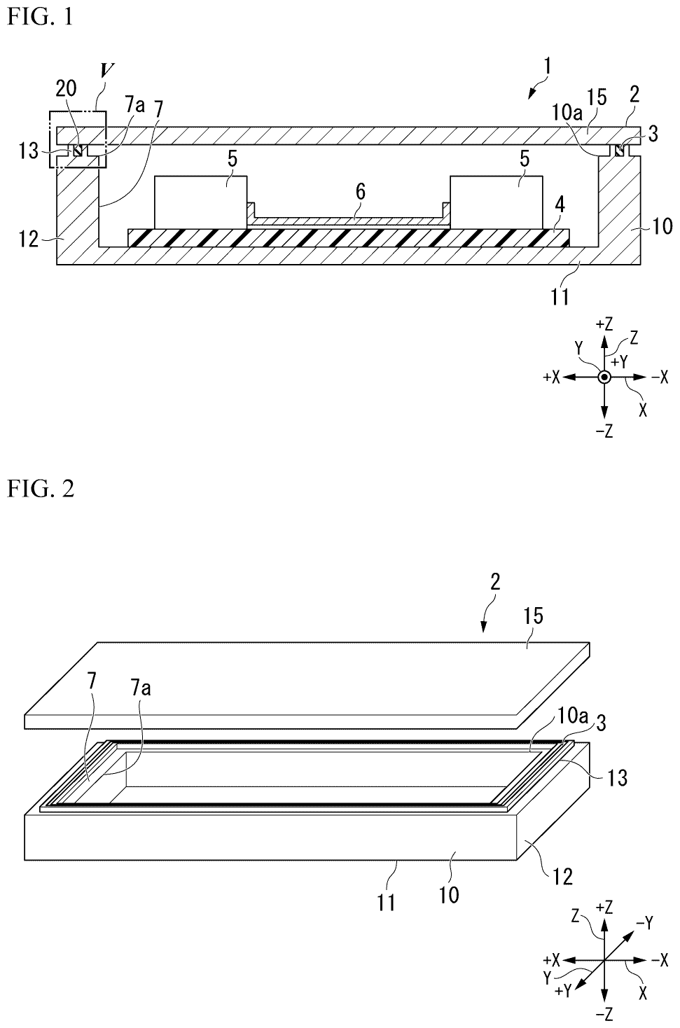

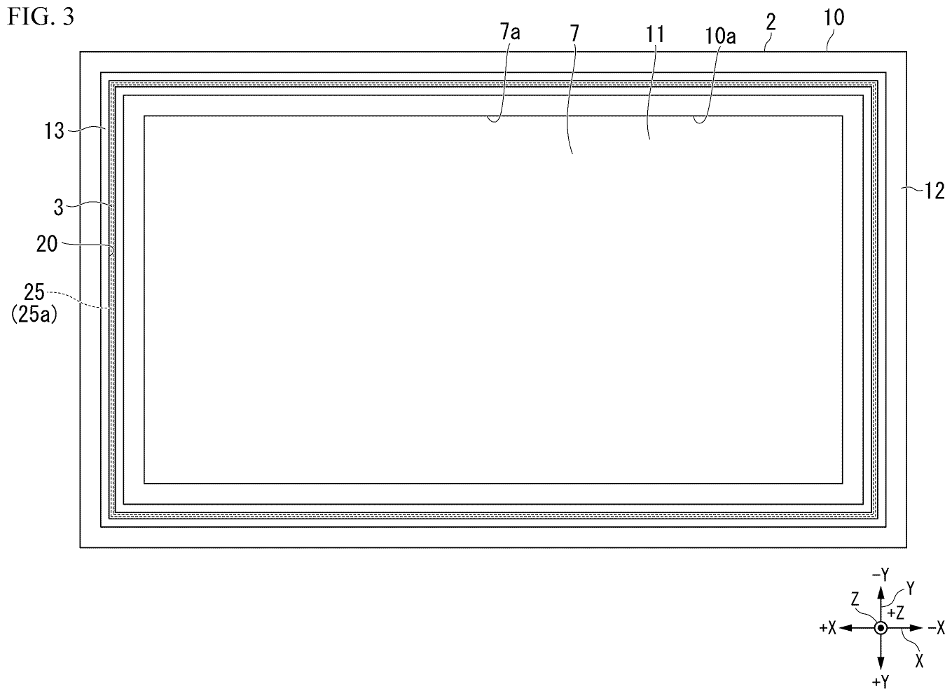

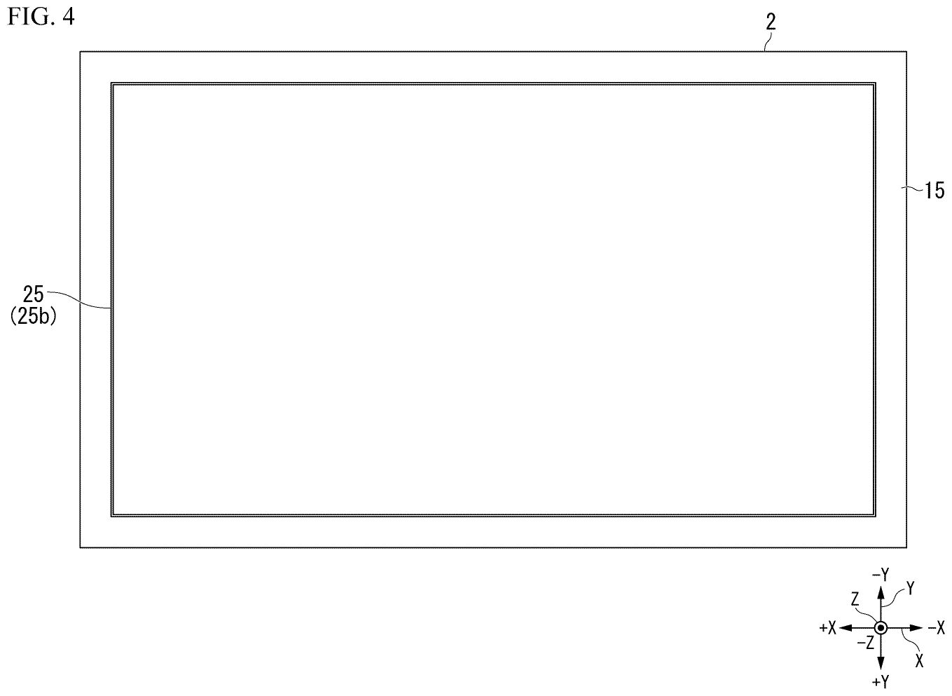

As shown in FIG. 2, the case 10 is formed in a rectangular parallelepiped shape. The case 10 has an opening 10a that opens in the +Z direction. Inside the case 10, the base member 4, the plurality of electronic components 5, the bus bar 6, and the like, are housed. As shown in FIG. 3, the case 10 has a bottom wall 11, a peripheral wall 12, and a protrusion 13.

The bottom wall 11 is formed in a rectangular plate shape extending in the X direction and the Y direction. The peripheral wall 12 extends in the +Z direction from each edge of the bottom wall 11. An end of the peripheral wall 12 in the +Z direction, the protrusion 13 is formed. The protrusion 13 protrudes in the +Z direction from the peripheral wall 12. As shown in FIG. 3, the protrusion 13 is formed along the entire circumference of the opening 10a of the case 10. In the protrusion 13, a sealing groove 20 and a drain groove 25, which will be described later, are formed.

### <Cover>

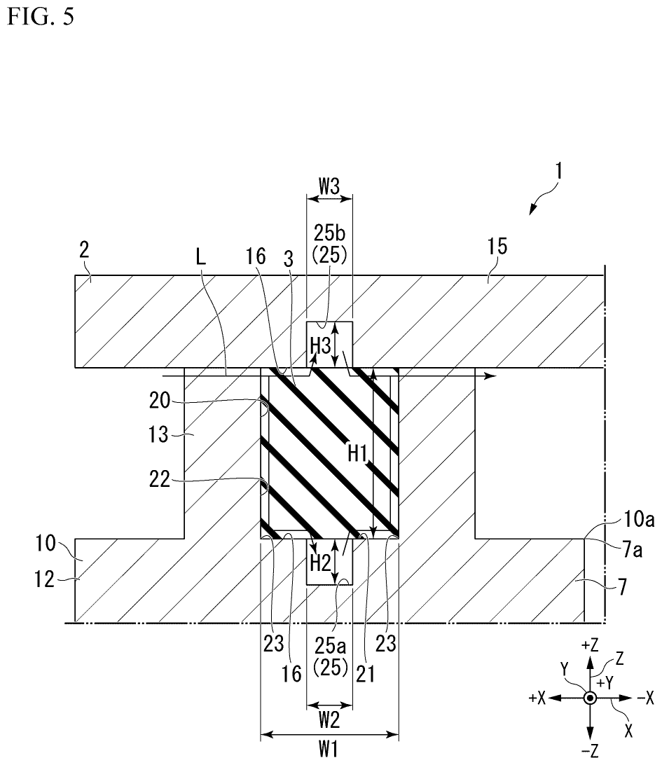

As shown in FIG. 1 and FIG. 2, the cover 15 overlaps the case 10 in the Z direction. The cover 15 together with the case 10 forms the housing chamber 7. The cover 15 is formed in a plate shape extending in the X direction and the Y direction. The cover 15 closes the opening 10a of the case 10. A face of the cover 15 facing the −Z direction abuts the entire face of a face of the protrusion 13 facing the +Z direction. Further, as shown in FIG. 4, the drain groove 25, which will be described later, is formed in a face of the cover 15, which faces the −Z direction and abuts the protrusion 13.

### Sealing Groove

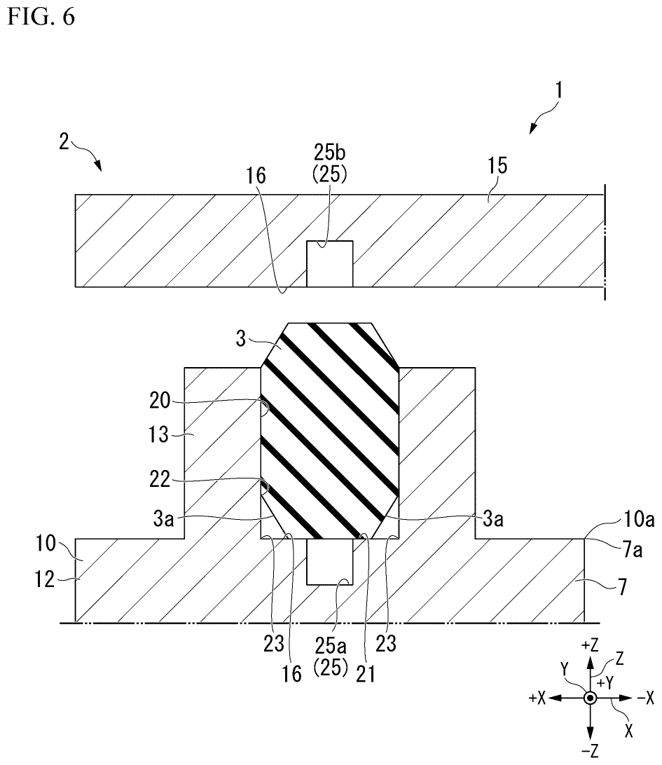

As shown in FIG. 1 and FIG. 3, the sealing groove 20 is disposed outside the housing chamber 7 when viewed from the Z direction. The sealing groove 20 is formed along the entire circumference of the opening 10a of the case 10 when viewed from the Z direction. In other words, the sealing groove 20 is formed along the entire circumference of an edge 7a of the housing chamber 7 when viewed from the Z direction. The sealing groove 20 is formed in a rectangular frame shape when viewed from the Z direction. In addition, the sealing groove 20 is formed to have a rectangular shape in cross section. As shown in FIG. 5, the sealing groove 20 opens in the +Z direction. Further, a depth H1 of the sealing groove 20 (the depth H1 of the sealing groove 20 in the Z direction in the example of FIG. 5) is equal to a protrusion height of the protrusion 13 (the protrusion height of the protrusion 13 in the Z direction in the example of FIG. 5). Because of this relationship, a bottom face 21 of the sealing groove 20 facing the +Z direction is positioned on the same plane with an end face of the peripheral wall 12 of the case 10 in the +Z direction side.

### Sealing Member

The sealing member 3 is disposed outside the housing chamber 7 when viewed from the Z direction. The sealing member 3 is disposed along the entire circumference of the opening 10a of the case 10 when viewed from the Z direction. In other words, the sealing member 3 is disposed along the entire circumference of an edge 7a of the housing chamber 7 when viewed from the Z direction. The sealing member 3 is formed in a rectangular frame shape when viewed from the Z direction. The sealing member 3 is compressed in the Z direction by the case 10 and the cover 15. The sealing member 3 is compressed by the case 10 and the cover 15 thereby sealing the housing chamber 7.

As shown in FIG. 6, the sealing member 3 extends in the +Z direction from the bottom face 21 of the sealing groove 20 and protrudes in the +Z direction from the protrusion 13 before the housing chamber 7 is sealed. The sealing member 3 before being sealed is formed in a rectangular shape extending in the Z direction when viewed in cross section. The sealing member 3 before being sealed has four corner portions 3a which are chamfered when viewed in cross section. The corner portion 3a of the sealing member 3 is spaced away from a corner 23 of the sealing groove 20 when viewed in cross section due to a chamfered shape of the corner portions 3a before the housing chamber 7 is sealed. After the housing chamber 7 is sealed, the sealing member 3 is compressed in the Z direction by the case 10 and cover 15. Hereafter, of a surface of the case 10 and a surface of the cover 15, a face with which the sealing member 3 is in contact is defined as a compressing face 16 after the housing chamber 7 is sealed. The compressing face 16 of the case 10 includes a bottom face 21 of the sealing groove 20 and lateral faces 22 extending in the +Z direction from the bottom face 21 of the sealing groove 20. The sealing member 3 after being sealed is in close contact with the compressing face 16 of the case 10 and the compressing face 16 of the cover 15. The sealing member 3 is a packing made of an insulative material such as rubber. When the case 10 and the cover 15 are separated in the Z direction, the sealing member 3 is restored to the shape before being sealed by its elastic force.

### Drain Groove

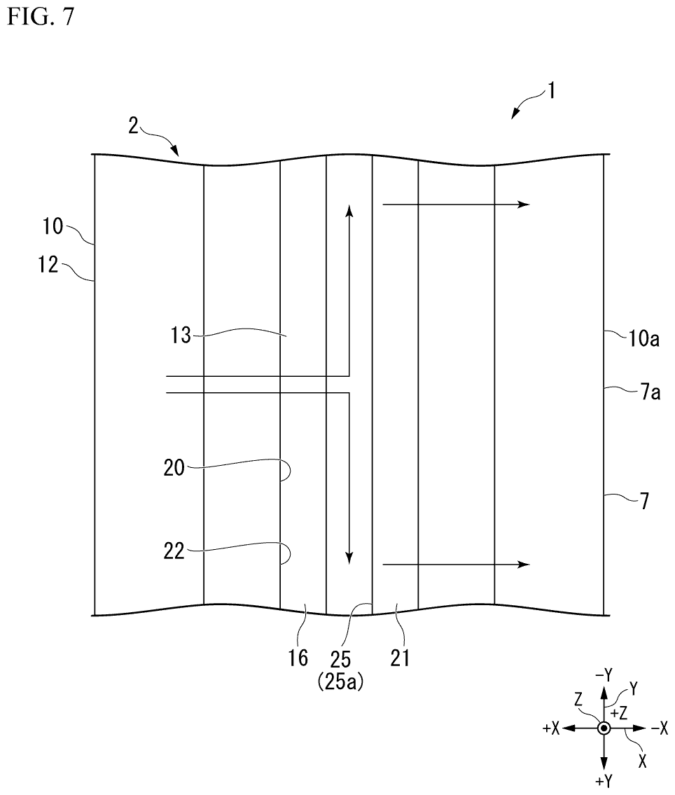

The drain groove 25 is formed in the compressing face 16. As shown FIG. 7, the drain groove 25 extends along the sealing groove 20. In the present embodiment, the drain grooves 25 are formed in both the case 10 and the cover 15. Hereafter, a drain groove 25 formed in the case 10 is defined as a first drain groove 25a and a drain groove 25 formed in the cover 15 is defined as a second drain groove 25b.

The first drain groove 25a is formed inside the sealing groove 20. The first drain groove 25a is formed at a position overlapping the sealing member 3 in the Z direction. In an illustrated example, the entire first drain groove 25a is positioned inside the sealing groove 20 when viewed from the Z direction. In addition, the first drain groove 25a opens in the +Z direction. In other words, the first drain groove 25a is formed in the bottom face 21 of the sealing groove 20 facing the +Z direction. Further, as shown in FIG. 3, the first drain groove 25a extends along the sealing groove 20 in a direction intersecting the Z direction. More specifically, the first drain groove 25a is formed along the entire circumference of the opening 10a of the case 10. In other words, the first drain groove 25a is formed along the entire circumference of the edge 7a of the housing chamber 7 when viewed from the Z direction. Further, the first drain groove 25a is formed in a rectangular frame shape when viewed from the Z direction. Further, the first drain groove 25a is formed to have a rectangular shape in cross section.

A width W2 of the first drain groove 25a (the width W2 of the first drain groove 25a in the X direction in the example of FIG. 5) is narrower than a width W1 of the sealing groove 20 (the width W1 of the sealing groove 20 in the X direction in the example of FIG. 5). A depth H2 of the first drain groove 25a (the depth H2 of the first drain groove 25a in the Z direction in the example of FIG. 5) is shallower than a depth H1 of the sealing groove 20 (the depth H1 of the sealing groove 20 in the Z direction in the example of FIG. 5).

The second drain groove 25b is formed at a position overlapping the sealing member 3 in the Z direction. In an illustrated example, the entire second drain groove 25b is positioned inside the sealing groove 20 when viewed from the Z direction. Furthermore, the second drain groove 25b is formed at a position facing the first drain groove 25a in the Z direction. In addition, the second drain groove 25b opens in the-Z direction. Further, as shown in FIG. 4, the second drain groove 25b extends in a direction intersecting the Z direction along the sealing groove 20. More specifically, the second drain groove 25b is formed along the entire circumference of the opening 10a of the case 10 in the same manner as the first drain groove 25a. In other words, the second drain groove 25b is formed along the entire circumference of the edge 7a of the housing chamber 7 when viewed from the Z direction. Further, the second drain groove 25b is formed in the same shape as the first drain groove 25a. That is, the second drain groove 25b is formed in a rectangular frame shape in the same manner as the first drain groove 25a when viewed from the Z direction. Further, the second drain groove 25b is formed to have a rectangular shape in cross section.

A width W3 of the second drain groove 25b (the width W3 of the second drain groove 25b in the X direction in the example of FIG. 5) is narrower than the width W1 of the sealing groove 20. A depth H3 of the second drain groove 25b (the depth H3 of the second drain groove 25b in the Z direction in the example of FIG. 5) is shallower than the depth H1 of the sealing groove 20. In addition, the width W3 of the second drain groove 25b is equal to the width W2 of the first drain groove 25a. The depth H3 of the second drain groove 25b is equal to the depth H2 of the first drain groove 25a.

### Housing Items Inside the Housing

As shown in FIG. 1, the base member 4, the electronic components 5, and the bus bar 6 are housed inside the housing 2 described above. The base member 4 is disposed on the bottom wall 11 of the case 10. The base member 4 is made of an insulative material such as resin. As the base member 4, for example, a resin case or a resin plate may be used. In the illustrated example, the base member 4 extends in the X direction.

The electronic components 5 are disposed on the base member 4. As the electronic components 5, for example, a relay, a fuse, a battery, and the like, may be used. In the illustrated example, a plurality of electronic components 5 are provided. These electronic components 5 are arranged in the X direction. In addition, a substrate (not shown) is disposed on the base member 4 and the electronic components 5 may be disposed on the substrate. The bus bar 6 connects the plurality of electronic components 5 (two in the illustrated example).

### Operation and Effects

The junction box 1 houses the plurality of electronic components 5 in the housing chamber 7 inside the junction box 1. The housing chamber 7 is sealed by the sealing groove 20 formed in the case 10 (first housing member) and the sealing member 3 disposed inside the sealing groove 20. However, as shown in FIG. 5 and FIG. 7, a case is assumed where saltwater L enters the inside of the housing chamber 7 from a gap between the case 10 and the cover 15 (second housing member) and salt in the saltwater L is crystallized in the gap between the case 10 and the cover 15 and inside the housing chamber 7. In FIG. 5 and FIG. 7, possible entering routes of saltwater L are shown using arrows.

In the present embodiment, the sealing groove 20 that is formed outside the housing chamber 7 when viewed from the Z direction (a first direction), that opens in the Z direction, and in which the sealing member 3 is disposed is formed in the case 10. In the case 10 and the cover 15, the drain grooves 25 formed in the compressing faces 16 being in contact with the sealing member 3 are formed. As shown in FIG. 6, the junction box 1 can drain saltwater L flowing from the outside to the inside of the housing chamber 7 into the drain grooves 25. As a result, saltwater L is prevented from entering the inside of the housing chamber 7, and it takes more time for saltwater L to enter the inside of the housing chamber 7. In addition, the drain grooves 25 only have to be formed in the case 10 and the cover 15, and thus, it is possible to use a general rubber packing or the like as the sealing member 3.

In addition, in the present embodiment, the first drain groove 25a of the drain grooves 25 is formed inside the sealing groove 20. Saltwater L is likely to accumulate inside the sealing groove 20, but in the present embodiment, the junction box 1 can drain the saltwater L accumulated inside the sealing groove 20 into the first drain groove 25a. As a result, saltwater L is further prevented from entering the inside of the housing chamber 7.

The saltwater that tries to enter the inside of the housing chamber 7 moves in a direction intersecting the Z direction, but in the present embodiment, the drain grooves 25 are formed at a position overlapping the sealing groove 20 in the Z direction and open in the Z direction. The junction box 1 can drain the saltwater L in the Z direction (a direction which is perpendicular to an entering direction of saltwater L) intersecting the entering direction by the drain grooves 25 opening in the Z direction. As a result, saltwater L is further prevented from entering the inside of the housing chamber 7.

In addition, in the present embodiment, the drain grooves 25 are formed in both the case 10 and the cover 15. Comparing with a case where the drain groove 25 is formed in only one of the case 10 and the cover 15, the junction box 1 can drain more saltwater L into the drain grooves 25. As a result, saltwater L is further prevented from entering the inside of the housing chamber 7.

In addition, in the present embodiment, the drain grooves 25 extend in a direction intersecting the Z direction. Thus, the junction box 1 can further drain saltwater L collected inside the drain grooves 25 in a direction intersecting the Z direction.

Furthermore, the drain grooves 25 are formed along the entire circumference of the edge 7a of the housing chamber 7 when viewed from the Z direction. Thus, the junction box 1 can drain saltwater L into the entire circumference of the edge 7a of the housing chamber 7. As a result, saltwater L is further prevented from entering the inside of the housing chamber 7.

In addition, in the present embodiment, the housing 2 includes the case 10 which opens in the +Z direction and inside which the electronic components 5 are housed and the cover 15 that extends in a direction intersecting the Z direction and that closes the opening 10a of the case 10. Further, the drain grooves 25 are formed along the entire circumference of the opening 10a of the case 10 when viewed from the Z direction. As a result, assembling of the case 10 and the cover 15 and forming of the drain grooves 25 are facilitated. Therefore, a worker can easily fabricate the junction box 1.

In addition, in the present embodiment, the widths W2 and W3 of the drain grooves 25 are narrower than the width W1 of the sealing groove 20, and the depths H2 and H3 of the drain grooves 25 are shallower than the depth H1 of the sealing groove 20. With such a size of the drain grooves 25, the junction box 1 can drain saltwater L into the drain grooves 25 without impairing the airtightness of the housing chamber 7.

### <Other Modifications>

In the example of the above embodiment, the X direction, the Y direction, and the Z direction are the directions orthogonal to each other. However, the X direction, the Y direction, and the Z direction may not be orthogonal to each other but only have to intersect each other. Further, although the Z direction is defined as the vertical direction, the Z direction may not be the vertical direction. For example, the Z direction may be a direction oblique to the vertical direction, or may be the horizontal direction. Furthermore, although the +Z direction is defined as the upward direction and the −Z direction is defined as the downward direction, the +Z direction may be the downward direction and the −Z direction may be the upward direction.

In the example of the above embodiment, the housing 2 is made of a conductive material such as aluminum. However, the conductive material forming the housing 2 may be a metal other than aluminum. In addition, the housing 2 may be made of a resin material.

In the example of the above embodiment, the protrusion 13 is provided at the end of the peripheral wall 12 of the case 10 in the +Z direction. The sealing groove 20 in which the sealing member 3 is housed is formed in the protrusion 13. However, without providing the protrusion 13 in the case 10, the sealing groove 20 may be formed at the end of the peripheral wall 12 of the case 10 in the +Z direction.

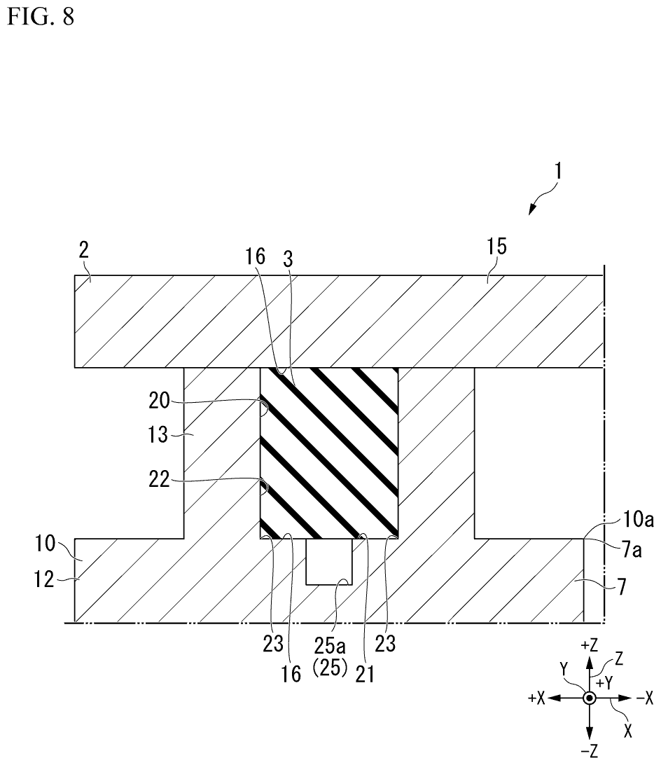

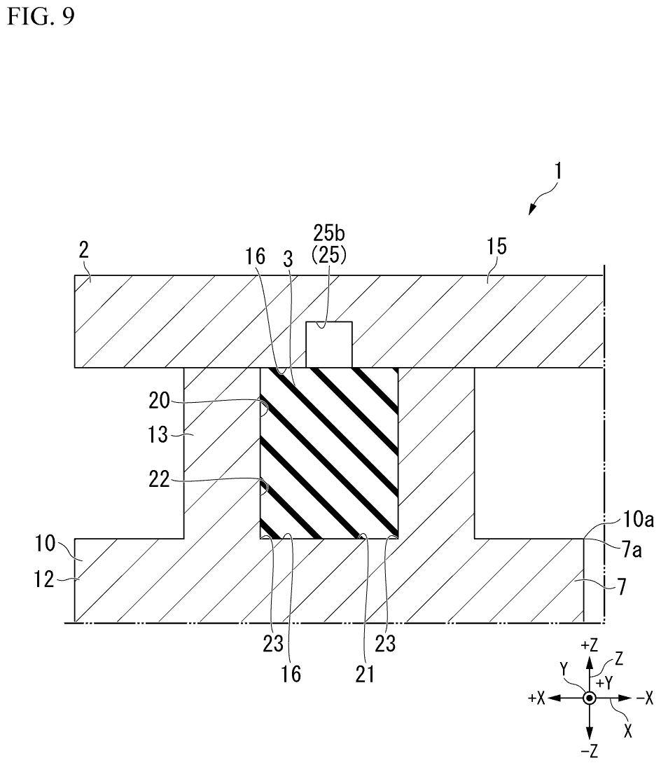

In the example of the above embodiment, the drain grooves 25 are formed in both the case 10 and the cover 15. However, as shown in FIG. 8 and FIG. 9, the drain groove 25 may be formed in one of the case 10 and the cover 15. In other words, only one of the first drain groove 25a and the second drain groove 25b may be formed in the housing 2.

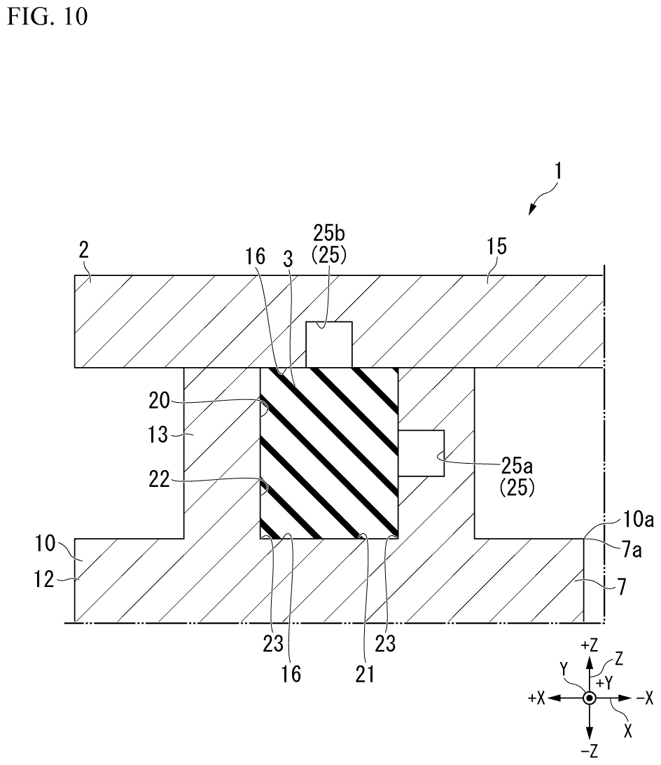

In the example of the above embodiment, the first drain groove 25a is formed in the bottom face 21 facing the Z direction, of the sealing groove 20. However, as shown in FIG. 10, the first drain groove 25a may be formed in the lateral face 22 that extends from the bottom face 21 in the Z direction, of the sealing groove 20. In this case the first drain groove 25a opens in a direction (the X direction in the illustrated example) intersecting the Z direction.

In addition, the shape and size of the sealing groove 20 can be modified as appropriate. Further, the shape, size, and forming position of the drain grooves 25 can be modified as appropriate. For example, part of the drain groove 25 only may overlap the sealing groove 20 in the Z direction. Further, the first drain groove 25a and the second drain groove 25b may be formed so as to be displaced in a direction intersecting the Z direction. In addition, the size of the first drain groove 25a and the size of the second drain groove 25b may not be equal to each other.

In the example of the above embodiment, the first housing member is the case 10 opening in the +Z direction and the second housing member is the cover 15 having a plate shape and closing the opening 10a of the case 10. In addition, the first housing member and the second housing member only have to form the housing chamber 7 housing the electronic components 5. The shape of the first housing member and the shape of the second housing member can be modified as appropriate. For example, the shape of the second housing member may be formed in the same shape as the case 10.

While preferred embodiments of the invention have been described and illustrated above, it should be understood that these are exemplary examples of the invention and are not to be considered as limiting. The embodiments described above can be implemented in various other forms, and various additions, omissions, substitutions, and other modifications can be made without departing from the scope of the present invention.

### INDUSTRIAL APPLICABILITY

According to the present disclosure, the junction box can prevent saltwater from entering the junction box.

### BRIEF DESCRIPTION OF THE REFERENCE SYMBOLS

1 Junction box
2 Housing
3 Sealing member
3a Corner portion
4 Base member
5 Electronic component
6 Bus bar
7 Housing chamber
7a Edge
10 Case (First housing member)
10a Opening
11 Bottom wall
12 Peripheral wall
13 Protrusion
15 Cover (Second housing member)
16 Compressing face
20 Scaling groove
21 Bottom face
22 Lateral face
23 Corner
25 Drain groove
25a First drain groove
25b Second drain groove 25b
H1 Depth
H2 Depth
H3 Depth
L Saltwater
W1 Width
W2 Width
W3 Width

What is claimed is:

1. A junction box comprising:
a housing including a first housing member and a second housing member, the second housing member overlapping the first housing member in a first direction and forming a housing chamber together with the first housing member, the housing chamber housing an electronic component; and
a sealing member disposed outside the housing chamber when viewed from the first direction, and compressed in the first direction by the first housing member and the second housing member,
wherein a sealing groove that is formed outside the housing chamber when viewed from the first direction, that opens in the first direction, and in which the sealing member is disposed is formed in the first housing member, and
a drain groove formed on a face being in contact with the sealing member is formed in at least one of the first housing member and the second housing member.

2. The junction box according to claim 1,
wherein the drain groove is formed inside the sealing groove.

3. The junction box according to claim 1,
wherein the drain groove is formed at a position overlapping the sealing member in the first direction and opens in the first direction.

4. The junction box according to claim 1,
wherein the drain groove is formed in both the first housing member and the second housing member.

5. The junction box according to claim 1,
wherein the drain groove is formed along the entire circumference of an edge of the housing chamber when viewed from the first direction.

6. The junction box according to claim 1,
wherein the first housing member is a case that opens in a direction from the first housing member to the second housing member in the first direction and inside which the electronic component is housed,
the second housing member is a cover that extends in a direction intersecting the first direction and that closes an opening of the case, and
the drain groove is formed along the entire circumference of the opening of the case when viewed in the first direction.
